(19) United States
(12) Patent Application Publication
(10) Pub. No.: US 2005/0216740 A1
(43) Pub. Date: Sep. 29, 2005

(54) Method and apparatus for reducing the use of signalling plane in certificate provisioning procedures

(76) Inventors: Pekka Laitinen, Helsinki (FI); Nadarajah Asokan, Espoo (FI); Risto Kuusela, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/505,256

(22) PCT Filed: Feb. 22, 2002
(86) PCT No.: PCT/IB02/01504

§ 371 Date: Sep. 21, 2004

(51) Int. Cl. H04K 1/00

(52) U.S. Cl. 713/175; 705/67

(57) ABSTRACT

Method and apparatus for dealing with digital certificate requests in a mobile telecommunications network. A request for a digital certificate is sent from a subscriber to a network element via the network, the request including a first part and a second part. The first part is sent via an authenticated communication channel of the network and the second part is sent via an unprotected communication channel of the network.

### FIELD OF INVENTION

The present invention relates to mobile telecommunications device security, and, in particular, to the requesting and issuing of digital certificates.

The invention has been developed primarily for use with mobile telephones and communication devices for use with third generation Universal Mobile Telecommunications System (UMTS) networks and will be described primarily with reference to this application. However, it will be appreciated that the invention has application under many other standards and protocols.

### BACKGROUND OF INVENTION

It is becoming increasingly common for transactions to be carried out by electronic means. In financial transactions, and in many other transactions, there is a need to establish a level of trust between the parties to the transaction. For example, if a purchaser wishes to buy goods on-line then the supplier of the goods must be satisfied that the purchaser will provide payment for the goods. The purchaser may also want to be satisfied that his payment is indeed to be transferred to the supplier.

One means for such trust to be established is by a public/private key system. In such a system, each user has a pair of keys. One key is a public key (PK), which can be made available to other users. The other key is a private key, which is held secret by the user whose key it is. The public and private keys are related by algorithms such that, whilst it is extremely difficult to generate the private key from knowledge of the public key, the private key and public key can be used for digital signing.

In digital signing a first algorithm is applied by a user to his private key and source data, to form result data; then the result data is transmitted to another user. The other user applies a second algorithm to the first user's public key, the result data, and, depending on the signature scheme, other input, to form verification data.

The public and private key and the first and second algorithms are related such that the verification data indicates to high level of probability that the first user's private key was used to generate the result data, and provided the first user's private key is secret to him, and that the second user can trust that the public key really belongs to the first user, this authenticates the first user to a high level of probability. An example of such a system is the Pretty Good Privacy PGP public/private key system.

A digital certificate is normally used to bind an identity of a subject to a public key. Certificates are themselves signed statements issued by a certification authority (CA). If a user has the authority's public key, he can verify certificates issued by that authority. If one user (verifier) has a certificate issued for the public key of another user (signer) by an authority trusted by the verifier, then the verifier can really trust that the public key belongs to the signer. This type of certificate is known as an identity certificate.

Authentication using identity certificates is not sufficient for transactions requiring authorization. For example, in the case of an online purchase, the seller may want to verify not just, and not even necessarily, the identity of the purchaser but also that the purchaser has the money to pay for the purchase. In addition, the certificate issuing party typically has legal and business responsibilities concerning how its certificates are used. For these reasons each certificate normally contains parameters that define how that certificate should be used. Examples of those parameters are the purpose for which the certificate has been issued, certificate expiration time and the limit on the amount of money allowed in a single transaction using the certificate. Certificates may relate to a single transaction or may be used to authorize a number of transactions each within a value limit specified in the certificate.

During the issuing of a digital certificate over a network connection, at least two messages must be exchanged between the requesting and the issuing parties. Those two messages are the certification request sent by the requesting party and a corresponding reply sent by the issuing party. There are standards for the issuing procedure, e.g. PKCS10 by RSA (see especially PKCS #10, v1.7: Certification Request Syntax Standard, RSA Laboratories, May 26, 2000) and RFC 2511 [CRMF] by the IETF pkix working group (Internet X.509 Certificate Request Message Format, RFC 2511).

Certificate issuing over a network can be secured in a number of ways. For example, Nokia's U.S. patent application “System and method of bootstrapping a temporary public-key infrastructure from a cellular telecommunication authentication and billing infrastructure,” U.S. Ser. No. 09/659,781, Sep. 11, 2000, (and corresponding applications) describes a system in which the security of the certificate request and reply messages is based on a secret known by both mobile terminal and the cellular network. In general, certificate request may be secured by attaching an authenticator field to it, which may be, for example, message authentication code computed using a shared secret.

In the case of UMTS subscriber certificates, the UMTS integrity key (IK) can be used to authenticate the certificate request, as discussed in U.S. application Ser. No. 09/659,781 referenced above. One way to do this would be to individually IK protect all certificate requests and replies. However, this requires additional processing time and resources. Another way is to send all certificate requests and replies as signaling messages, because in UMTS (for example) the signaling plane is automatically IK protected. However, certificate request and response messages are relatively large, so it is not desirable to send them, in their entirety, via the signaling plane because it has a relatively low bandwidth. On the other hand only some parts of these messages need to be protected. In a typical certificate request scenario, the main critical object that should be protected by IK is the subscriber's public key in the request (i.e., an attacker should not be able to substitute his own public key into the certificate request).

In addition to requesting certificates for their own public keys, a subscriber may ask for the operator's public key or certificate so that his device can verify certificates issued to other users (such as a seller). Here, too, a similar concern arises. The critical object to be protected in this case is the operator's public key (i.e., an attacker should not be able do substitute his own certificate into the reply to the operator certificate request). But the certificate is large, and sending it in its entirety via the signaling plane may be prohibitively expensive in resource terms.

Both of these protocols (requesting a subscriber certificate, and retrieving the operator certificate) are of the general form shown in FIG. 1. In both, the critical objects are long (several hundred bytes). There may be other non-critical but long objects sent as part of the request or response: examples include, proof-of-possession (which is a signature made on the request message using the subscriber's private key), other certificates issued for the subscriber's public key (e.g., device certificate issued by manufacturer), certificate chains, etc.

It would be desirable to achieve the required level of security by taking advantage of automatic authentication available on a signaling plane, whilst reducing the amount of data sent via the signaling plane.

### SUMMARY OF INVENTION

In a first aspect, the present invention provides a method for requesting a digital certificate in a mobile telecommunications network, the method including the steps of:
sending a request for a digital certificate from a subscriber to a network element via the network, the request including a first part and a second part;
wherein the first part is sent via an authenticated communication channel of the network and the second part is sent via an unprotected communication channel of the network.

Preferably, the first part includes data that is relatively more security-critical than data in the second part.

In a preferred form, the method further includes the step of sending a response to the request, the response including a third part and a fourth part. The third part is sent via an authenticated communication channel of the network and the fourth part is sent via an unprotected communication channel of the network. More preferably, the third part includes data that is relatively more security-critical than data in the fourth part.

In the preferred form, the authenticated channel is a signaling plane; and the unprotected channel is a user plane.

Preferably, the first part includes a cryptographic hash of the public key of the subscriber.

Preferably the third part includes a continuation address, and the second part is sent to the continuation address and includes the public key of the subscriber.

In a preferred embodiment, the first and second parts are securely linked by checking that the hash received in the first part matches the public key received in the second part.

Preferably, the fourth part includes a subscriber certificate for the public key issued by an operator certification authority. More preferably, the first and second parts are securely linked by checking that the hash received in the first part matches the subscriber certificate received in the second part.

In one form, the fourth part contains a further continuation address which triggers a further exchange of one or more rounds of request and response messages, the final of these messages containing a certificate for the public key of the subscriber issued by the operator certification authority.

In a preferred embodiment, the subscriber's public key is sent after the second part is transmitted, at a time determined by the operator certification authority.

Preferably, the fourth part includes a certificate of the public key of the operator certification authority or the public key of the operator certification authority. More preferably, the third part includes a cryptographic hash of the certificate or public key of the operator certification authority, the third and fourth parts being securely linked by checking that the hash received in the third part matches the certificate or public key received in the fourth part.

Preferably, the first and/or third parts include additional security-critical data. Preferably also, the second and/or fourth parts include additional non security-critical data.

In a second aspect, the present invention provides communication network apparatus for processing a request for a digital certificate in a mobile telecommunications network, the apparatus being configured to:
receive at a network element a request for a digital certificate from a subscriber, the request including a first part and a second part;
wherein the first part is sent via an authenticated communication channel of the network and the second part is sent via an unprotected communication channel of the network.

In a third aspect, there is provided mobile user equipment (UE) for requesting a digital certificate from a network entity in a mobile telecommunications network, the UE being configured to:
send a request for a digital certificate to the network element via the network, the request including a first part and a second part;
wherein the first part is sent via an authenticated communication channel of the network and the second part is sent via an unprotected communication channel of the network.

In essence, in a certification request/response process, relatively long critical objects such as the subscriber's public key or the operator's public key are replaced by, for example, a short cryptographic hash. The hash is sent over the signaling plane. The full objects, and optionally other related non-critical objects (that is, objects that do not require protection by IK) are then sent over the user plane. In the preferred form, the messages sent over the user plane are linked to the messages sent over the signaling plane.

### BRIEF DESCRIPTION OF DRAWINGS

Preferred and other embodiments of the invention will now be described, by way of example only, with reference to the accompanying drawings, in which:

FIG. 1 is a schematic diagram of certificate request and response between a mobile telephone MT and a Certification Authority CA, in accordance with the invention; and

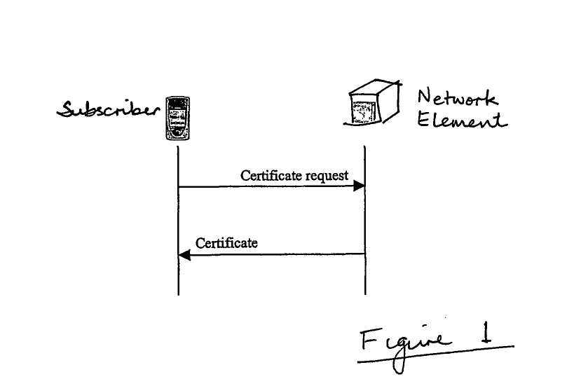

FIG. 2 is a schematic diagram of the steps involved in making a request and receiving a response, in accordance with the invention.

### DETAILED DESCRIPTION OF PREFERRED AND OTHER EMBODIMENTS

### EXAMPLE 1

### Subscriber Certificate Request

Over the authenticated channel:
Mobile Terminal (MT)→CA: hash of public key of the subscriber (PK_subscriber), <other critical fields> (part 1)
CA÷MT: continuation URL (part 3)

Over the unprotected channel:
MT→(CA at) continuation URL: PK_subscriber (part 2)
CA→MT: Cert of PK_subscriber (part 4)

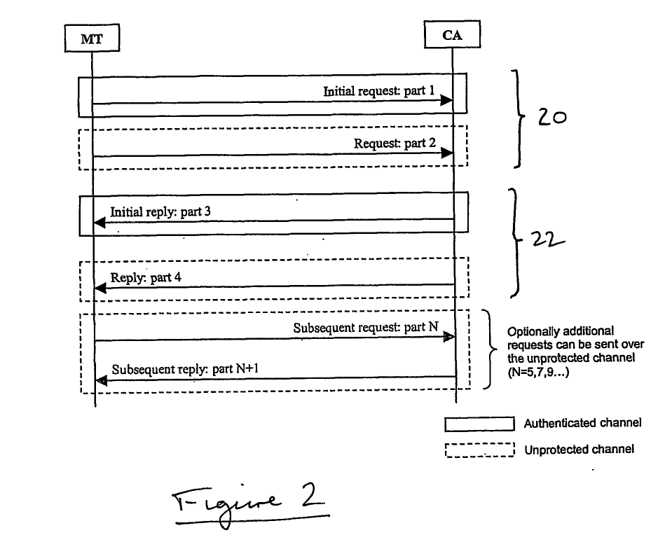

As summarized immediately above, and referring to FIG. 2, the MT sends a certificate request 20 to the CA. The request includes two parts, which will be referred to as part 1 and part 2.

Part 1 contains a hash generated by applying a cryptographic hash function to the subscriber's public key. The hash is relatively small (tens of bytes) compared to the original public key (hundreds of bytes). It is necessary to ensure that the hash is kept secure from security attacks, because otherwise a hacker could replace it (and the rest of the message) with his own public key and hash. Accordingly, the first part is sent via an authenticated channel. In the UMTS case being described, this takes the form of the signaling plane, which is automatically IK authenticated.

Because the CA still requires the subscriber's public key, this is sent in part 2 of the request 20. It is not as important that the subscriber's public key be kept secure, because any change to it in transit can be detected by CA as explained below, so part 2 is sent via an unauthenticated channel. In the UMTS case being described, this channel is the user plane.

Once generated, the certificate is also sent back to the MT from the CA via two channels. One of those parts, called part 3 in this description, includes a continuation Uniform Resource Locator (URL). This is sent via the authenticated channel (signaling plane). The other part, called part 4 in this description, includes the requested certificate and is sent via the unprotected channel. It will be appreciated that before sending part 4, the CA computes whether the hash of the public key PK_subscriber received in part 2 is the same as the hash value received in part 1.

Optionally, the CA may ask the MT to engage in additional rounds of communication (parts 5, 6 . . . ) over the unprotected channel.

### EXAMPLE 2

### Operator Certificate Request

Over the authenticated channel:
MT→CA: operator certificate request (part 1)
CA→MT: continuation URL with hash of the CA's certificate (CA_cert) (part 3)

Over the unprotected channel:
MT→(CA at) continuation URL (part 2)
CA→MT: CA_cert (part 4)

The scenario is an operator certificate request procedure that is analogous to the described in relation to Example 1 and would typically take place immediately after Example 1 has taken place. In this case, part 1 includes an operator certificate request sent over the authenticated channel. Part 2 is sent to the continuation URL received by the MT in part 3.

In response, the CA sends part 3 which includes a further continuation URL along with the hash of the CA certificate. Again, part 3 is sent via the authenticated channel. Finally, part 4, which includes the CA certificate, is sent to the MT from the CA.

The MT then computes the hash of the certificate CA_cert obtained in part 4 and checks if it is the same as the hash received in part 3.

### EXAMPLE 3

### Proof of Possession

When an MT sends a certificate request to the CA over the authenticated channel, the CA may reply with a continuation URL. The MT will then visit the continuation URL and run a proof-of-possession (PoP) protocol.

This can be summarised as follows:

Over the authenticated channel:
MT→CA: hash of PK_subscriber , <other critical fields> (part 1)
CA→MT: continuation URL (part 3)

Over the unprotected channel:
MT→(CA at) continuation URL: PK_subscriber (part 2)
CA→MT: A random challenge to be signed (part 4)

After receiving part 2, the CA makes the same check between the cryptographic hash of the PK (in part 1) and the PK itself (in part 3) as in Example 1.

(The contents of part 4 and subsequent message are broadly similar to the example in Section 7.3.4 of “Wireless Application Protocol: Public Key Infrastructure Definition”, WAP-217-WPKI, Version 24Apr. 2001).
MT→CA: signature using the private key of the subscriber (part 5)
CA→MT: Cert of PK_subscriber (part 6)

There are several ways to handle the continuation URL in the MT. One example would be to use WAP Push. In this case the continuation URL is sent by a Push Initiator (the CA) to a Push Proxy Gateway, which in turn delivers it to the MT (See “Wireless Application Protocol: WAP Push Architectural Overview”, WAP-250-PushArchOverview, Version 3 Jul. 2001). In this case, part 2 is not needed.

It will be appreciated that although the preferred embodiment has been described in relation to a mobile subscriber requesting a certificate from a fixed network element, it is not intended that the scope of the invention be limited to this arrangement.

The present invention allows for a reduction in the amount of data sent via an authenticated channel. This is especially useful where such a channel has a limited bandwidth compared to other available channels and is achieved whilst maintaining the required level of security.

Although the invention has been described with reference to a number of specific examples, it will be appreciated that the invention can be embodied in many other forms.

1. A method for requesting a digital certificate in a mobile telecommunications network, the method including the steps of:
sending a request for a digital certificate from a subscriber to a network element via the network, the request including a first part and a second part;
wherein the first part is sent via an authenticated communication channel of the network and the second part is sent via an unprotected communication channel of the network.

2. A method according to claim 1, wherein the first part includes data that is relatively more security-critical than data in the second part.

3. A method according to claim 1, further including the steps of:
sending a response to the request, the response including a third part and a fourth part;
wherein the third part is sent via an authenticated communication channel of the network and the fourth part is sent via an unprotected communication channel of the network.

4. A method according to claim 3, wherein the third part includes data that is relatively more security-critical than data in the fourth part.

5. A method according to claim 1, wherein:
the authenticated channel is a signaling plane; and
the unprotected channel is a user plane.

6. A method according to claim 1, wherein the first part includes a cryptographic hash of the public key of the subscriber.

7. A method according to claim 6, wherein the third part includes a continuation address, and the second part is sent to the continuation address and includes the public key of the subscriber.

8. A method according to claim 7, wherein the first and second parts are securely linked by checking that the hash received in the first part matches the public key received in the second part.

9. A method according to claim 6, wherein the fourth part includes a subscriber certificate for the public key issued by an operator certification authority.

10. A method according to claim 9, wherein the first and second parts are securely linked by checking that the hash received in the first part matches the subscriber certificate received in the second part.

11. A method according to claim 6, wherein the fourth part contains a further continuation address which triggers a further exchange of one or more rounds of request and response messages, the final of these messages containing a certificate for the public key of the subscriber issued by the operator certification authority.

12. A method according to claim 6, wherein the subscriber's public key is sent after the second part is transmitted, at a time determined by the operator certification authority.

13. A method according to claim 3, wherein the fourth part includes a certificate of the public key of the operator certification authority or the public key of the operator certification authority.

14. A method according to claim 13, wherein the third part includes a cryptographic hash of the certificate or public key of the operator certification authority, the third and fourth parts being securely linked by checking that the hash received in the third part matches the certificate or public key received in the fourth part.

15. A method according to claim 3, wherein the first and/or third parts include additional security-critical data.

16. A method according to claim 3, wherein the second and/or fourth parts include additional non security-critical data.

17. Communication network apparatus for processing a request for a digital certificate in a mobile telecommunications network, the apparatus being configured to:
receive at a network element a request for a digital certificate from a subscriber, the request including a first part and a second part;
wherein the first part is sent via an authenticated communication channel of the network and the second part is sent via an unprotected communication channel of the network.

18. Communication network apparatus according to claim 17, wherein the first part includes data that is relatively more security-critical than data in the second part.

19. Communication network apparatus according to claim 17, further including the steps of:
sending a response to the request, the response including a third part and a fourth part;
wherein the third part is sent via an authenticated communication channel of the network and the fourth part is sent via an unprotected communication channel of the network.

20. Communication network apparatus according to claim 19, wherein the third part includes data that is relatively more security-critical than data in the fourth part.

21. Communication network apparatus according to claim 17, wherein:
the authenticated channel is a signaling plane; and
the unprotected channel is a user plane.

22. Communication network apparatus according to claim 17, wherein the first part includes a cryptographic hash of the public key of the subscriber.

23. Communication network apparatus according to claim 22, wherein the third part includes a continuation address, and the second part is sent to the continuation address and includes the public key of the subscriber.

24. Communication network apparatus according to claim 23, wherein the first and second parts are securely linked by checking that the hash received in the first part matches the public key received in the second part.

25. Communication network apparatus according to claim 6, wherein the fourth part includes a subscriber certificate for the public key issued by an operator certification authority.

26. Communication network apparatus according to claim 25, wherein the first and second parts are securely linked by checking that the hash received in the first part matches the subscriber certificate received in the second part.

27. Communication network apparatus according to claim 22, wherein the fourth part contains a further continuation address which triggers a further exchange of one or more rounds of request and response messages, the final of these messages containing a certificate for the public key of the subscriber issued by the operator certification authority.

28. Communication network apparatus according to claim 22, wherein the subscriber's public key is sent after the second part is transmitted, at a time determined by the operator certification authority.

29. Communication network apparatus according to claim 19, wherein the fourth part includes a certificate of the public key of the operator certification authority or the public key of the operator certification authority.

30. Communication network apparatus according to claim 29, wherein the third part includes a cryptographic hash of the certificate or public key of the operator certification authority, the third and fourth parts being securely linked by checking that the hash received in the third part matches the certificate or public key received in the fourth part.

31. Communication network apparatus according to claim 19, wherein the first and/or third parts include additional security-critical data.

32. Communication network apparatus according to claim 19, wherein the second and/or fourth parts include additional non security-critical data.

33. Mobile user equipment (UE) for requesting a digital certificate from a network entity in a mobile telecommunications network, the UE being configured to:
send a request for a digital certificate to the network element via the network, the request including a first part and a second part;
wherein the first part is sent via an authenticated communication channel of the network and the second part is sent via an unprotected communication channel of the network.

34. Mobile user equipment according to claim 33, wherein the first part includes data that is relatively more security-critical than data in the second part.

35. Mobile user equipment according to claim 33, being configured to:
receive a response to the request, the response including a third part and a fourth part;
wherein the third part is received via an authenticated communication channel of the network and the fourth part is received via an unprotected communication channel of the network.

36. Mobile user equipment according to claim 35, wherein the third part includes data that is relatively more security-critical than data in the fourth part.

37. Mobile user equipment according to claim 33, wherein:
the authenticated channel is a signaling plane; and
the unprotected channel is a user plane.

38. Mobile user equipment according to claim 35, wherein the first part includes a cryptographic hash of the public key of the subscriber.

39. Mobile user equipment according to claim 38, wherein the third part includes a continuation address, and the second part is sent to the continuation address and includes the public key of the subscriber.

40. Mobile user equipment according to claim 39, wherein the first and second parts are securely linked by checking that the hash received in the first part matches the public key received in the second part.

41. Mobile user equipment according to claim 38, wherein the fourth part includes a subscriber certificate for the public key issued by an operator certification authority.

42. Mobile user equipment according to claim 41, wherein the first and second parts are securely linked within the network by checking that the hash received in the first part matches the subscriber certificate received in the second part.

43. Mobile user equipment according to claim 38, wherein the fourth part contains a further continuation address which triggers a further exchange of one or more rounds of request and response messages, the final of these messages containing a certificate for the public key of the subscriber issued by the operator certification authority.

44. Mobile user equipment according to claim 38, wherein the subscriber's public key is received after the second part is transmitted, at a time determined by the operator certification authority.

45. Mobile user equipment according to claim 35, wherein the fourth part includes a certificate of the public key of the operator certification authority or the public key of the operator certification authority.

46. Mobile user equipment according to claim 45, wherein the third part includes a cryptographic hash of the certificate or public key of the operator certification authority, the third and fourth parts being securely linked by checking that the hash received in the third part matches the certificate or public key received in the fourth part.

47. Mobile user equipment according to claim 35, wherein the first and/or third parts include additional security-critical data.

48. Mobile user equipment according to claim 35, wherein the second and/or fourth parts include additional non security-critical data.
